(19) United States
(12) Patent Application Publication
(10) Pub. No.: US 2025/0003133 A1
(43) Pub. Date: Jan. 2, 2025

(54) DRYING MACHINE FOR PERFORMING DRYING FUNCTION ON BASIS OF EXTERNAL ENVIRONMENTAL INFORMATION, AND CONTROL METHOD THEREFOR

(71) Applicant: LG ELECTRONICS INC., Seoul (KR)

(72) Inventor: Jonghoon CHAE, Seoul (KR)

(73) Assignee: LG ELECTRONICS INC., Seoul (KR)

(21) Appl. No.: 18/700,149

(22) PCT Filed: Nov. 9, 2021
(86) PCT No.: PCT/KR2021/016225

§ 371 Date: Apr. 10, 2024

(51) Int. Cl. D06F 34/28; D06F 34/26; D06F 58/38; D06F 103/04; D06F 103/08; D06F 105/12

(52) U.S. Cl. CPC D06F 34/28; D06F 34/26; D06F 58/38; D06F 2103/04; D06F 2103/08; D06F 2105/12

(57) ABSTRACT

A method for controlling a drying machine for performing a drying function on the basis of external environmental information, according to one embodiment of the present invention, comprises the steps of: receiving initial sensing values before starting drying; receiving object-to-be-dried analysis information; acquiring the external environmental information by providing the initial sensing values and the object-to-be-dried analysis information to a first artificial intelligence model; and drying objects to be dried, on the basis of the acquired external environmental information.

### TECHNICAL FIELD

The present disclosure relates to a drying machine, and more particularly, to a drying machine performing a drying function based on external environment information.

### BACKGROUND ART

Artificial intelligence (AI) refers to a field of computer engineering and information technology that studies how to enable computers to think, learn, and improve themselves in ways that humans can, which means enabling computers to mimic intelligent behavior of humans.

In addition, AI is not a standalone field, but is directly or indirectly related to other fields of computer science. In particular, many fields of information technology are nowadays trying to introduce AI elements and use them to solve problems in their fields.

Furthermore, various technologies for recognizing and learning a surrounding situation using AI and providing desired information to a user in a desired format or performing an operation or a function desired by a user have been researched.

There are few attempts to apply AI in the field of conventional drying machines. For example, only information about cases of AI attempts limited to the information inside the drying machine has been reported.

However, when a conventional drying machine is applied, the drying time is unnecessarily increased depending on the environment (e.g., humidity/temperature, etc.) of the space where the drying machine is installed.

For example, depending on the external environment in which the drying machine is installed, distortion can occur in a result value of the sensor in the inner space of the drying machine, and thus it is difficult to accurately diagnose the actual condition of clothing (drying target objects) inside the drying machine.

Further, due to the influence of an external environment in which the drying machine is installed, an error can occur in the process of accurately estimating the drying time by the sensors or the like inside the drying machine.

### DISCLOSURE

### Technical Problem

An embodiment of the present disclosure is directed to providing a drying machine that infers the external environment by analyzing a default sensed value and corrects distortions in the internal sensor of the drying machine based on the inference before the drying machine starts drying.

Another embodiment of the present disclosure is directed to providing a solution for more accurately predicting the minimum time required for drying in consideration of the external environment.

### Technical Solution

In one aspect of the present disclosure, provided herein is a method of controlling a drying machine for performing a drying function based on external environment information. The method can include receiving an initial sensed value before drying starts, receiving drying target object analysis information, providing the initial sensed value and the drying target object analysis information to a first artificial intelligence model, and

Acquiring external environment information, and drying a drying target object based on the acquired external environment information.

Further, the first artificial intelligence model can correspond to a neural network trained using the external environment information labeled on the drying target object analysis information and the initial sensed value.

In another aspect of the present disclosure, provided herein is a drying machine for performing a drying function based on external environment information, the drying machine can include a sensor configured to receive an initial sensed value before drying starts, a communication module configured to receive drying target object analysis information, a processor configured to provide the initial sensed value and the drying target object analysis information to a first artificial intelligence model and acquire external environment information, and a dryer configured to dry a drying target object based on the acquired external environment information.

In particular, the first artificial intelligence model can correspond to a neural network trained using, for example, the external environment information labeled on the drying target object analysis information and the initial sensed value.

### Advantageous Effects

According to an embodiment of the present disclosure, the drying time can be adaptively controlled according to the environment (humidity/temperature, etc.) of the drying machine installation space.

According to another embodiment of the present disclosure, the actual condition of clothing in the drying machine can be more accurately diagnosed by correcting the distortion occurring in the sensor space in the drying machine according to the environment.

According to another embodiment of the present disclosure, the issue of unnecessary increase in the drying time caused by the sensor error can be addressed.

In addition to the above-mentioned effects of the present disclosure, those skilled in the art will also fully appreciate the effects arising from the components included in the description and drawings of the present application.

### DESCRIPTION OF DRAWINGS

FIG. 1 is a flowchart illustrating a process of operating a drying machine according to the conventional technology.

FIG. 2 is a block diagram illustrating a detailed configuration of an AI device 100 according to an embodiment of the present disclosure.

FIG. 3 is a block diagram illustrating a detailed configuration of an AI server 200 according to an embodiment of the present disclosure.

FIG. 4 is a block diagram illustrating a configuration of a drying machine according to an embodiment of the present disclosure.

FIG. 5 is a view illustrating a washing machine connected to a drying machine over a network according to an embodiment of the present disclosure.

FIG. 6 is a flowchart illustrating a chronological sequence of operations of a drying machine according to an embodiment of the present disclosure.

FIG. 7 is a diagram illustrating a method of acquiring external environment information using a first artificial intelligence model according to an embodiment of the present disclosure.

FIG. 8 is a diagram illustrating a method of acquiring an optimal drying time using a second artificial intelligence model according to an embodiment of the present disclosure.

FIG. 9 is a diagram illustrating a method of predicting a drying completion time point of an actual drying target object using a third artificial intelligence model, according to an embodiment of the present disclosure.

FIG. 10 is a diagram illustrating an embodiment of changing a drying completion time point of an actual drying target object according to the prediction method of FIG. 9.

### BEST MODE

Hereinafter, embodiments disclosed herein will be described in detail with reference to the accompanying drawings. Wherever possible, the same reference numbers will be used throughout the drawings to refer to the same or like parts, and redundant descriptions thereof will be omitted. The suffixes “module” and “unit” of elements herein are used for convenience of description and thus are used interchangeably and do not have any distinguishable meanings or functions. Further, in describing the embodiments disclosed in this specification, if a detailed description of related known techniques would unnecessarily obscure the gist of the embodiments disclosed in this specification, detailed description thereof will be omitted. In addition, the attached drawings are provided for easy understanding of the embodiments disclosed in this specification and do not limit technical idea disclosed in this specification, and the embodiments should be construed as including all modifications, equivalents, and alternatives falling within the scope of the present disclosure.

Terms containing ordinal numbers, such as first and second can be used to describe various components, but the components are not limited by such terms. These terms are used only to distinguish one component from another.

When a component is described as being “connected” or “linked” to another component, it should be understood that it can be directly connected or linked to the other component, but there can be other components in between. On the other hand, when a component is described as being “directly connected” or “directly linked” to another component, it should be understood that there is no other component between the connected or linked components.

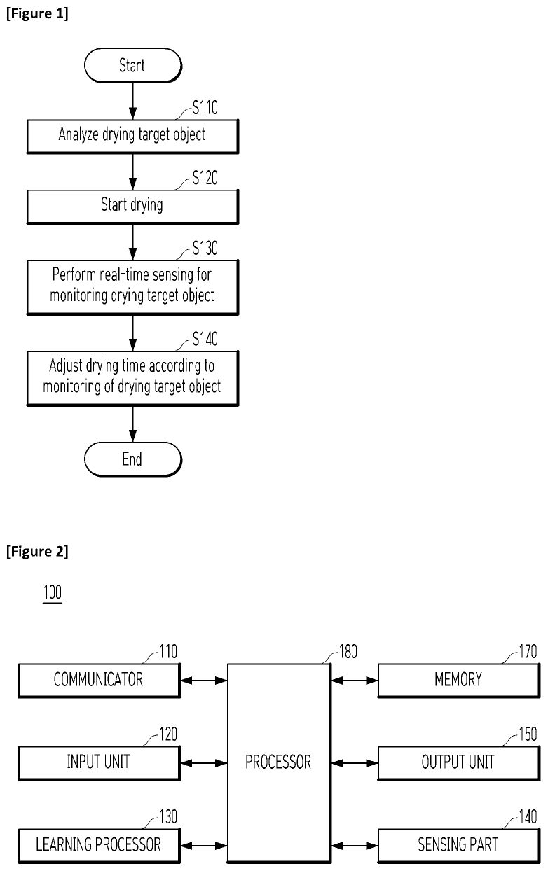

FIG. 1 is a flowchart illustrating a process of operating a drying machine according to the conventional technology.

According to the conventional technology, the drying machine analyzes the temperature/humidity of drying target objects inside the drying machine using a sensor or the like (S110). Then, based on the analysis, drying is started (S120). During the drying, additional sensing is performed in order to monitor the condition of the drying target objects (S130). Finally, the drying time is adjusted according to the result of monitoring the drying target objects (S140).

However, the conventional technology illustrated in FIG. 1 does not consider an external environment in which the drying machine is installed, and thus undergoes distortion of the initial sensed value (humidity/temperature, etc.). In particular, the distortion can become worse in winter, rainy seasons, and hot weather.

Furthermore, in operation S130, the drying machine is designed to sense the internal condition thereof even during the drying. Even in this case, the monitoring sensed value is distorted due to the external environment.

In addition, since incorrect data is acquired in operation S130, an error occurs when the drying time is adjusted in operation S140.

To address this issue, the present disclosure is designed to adopt various artificial intelligence (AI) models. Details will be described below.

First, artificial intelligence (AI) refers to a field of studying artificial intelligence or methodology for creating artificial intelligence, and machine learning refers to a field of defining various problems addressed in the AI field and studying methodology for solving the various problems. Machine learning is also defined as an algorithm that increases performance for a task through constant experience with that task.

An artificial neural network (ANN) is a model used in machine learning, and can refer to a whole class of models that have the ability to solve problems, consisting of artificial neurons (nodes) that are connected by synapses to form a network. An artificial neural network can be defined by a pattern of connections between neurons in different layers, a learning process that updates the model parameters, and an activation function that produces an output value.

The artificial neural network can include an input layer, an output layer, and optionally one or more hidden layers. Each layer can include one or more neurons, and the artificial neural network can include synapses connecting neurons. In the artificial neural network, each neuron can output function values of an activation function for input signals, weights, and biases that are input through the synapses.

Model parameters are parameters determined through learning, and include a weight of a synaptic connection and a bias of a neuron. Hyperparameters are parameters that should be set before learning in a machine learning algorithm, and include a learning rate, a number of repetitions, a mini batch size, and an initialization function.

Training an artificial neural network can intend to determine model parameters that minimize a loss function. The loss function can be used as a metric to determine optimal model parameters during the process of training the artificial neural network.

Machine learning can be classified into supervised learning, unsupervised learning, and reinforcement learning based on the learning method.

Supervised learning refers to training an artificial neural network given a label for the training data, where the label can mean a correct answer (or outcome value) that the artificial neural network should infer when the training data is input to the artificial neural network. Unsupervised learning can refer to a method of training an artificial neural network without being given a label for the training data. Reinforcement learning can refer to a learning method that trains an agent defined in a certain environment to select an action or sequence of actions that maximizes cumulative compensation in each state.

Machine learning implemented by a deep neural network (DNN) including multiple hidden layers among artificial neural networks is referred to as deep learning. Deep learning is a part of machine learning. Hereinafter, machine learning is used as a concept including deep learning.

FIG. 2 is a block diagram illustrating a detailed configuration of an AI device 100 according to an embodiment of the present disclosure.

The AI security device 100 can be mounted on various devices, and can be implemented as, for example, a washing machine, a drying machine, or the like.

As shown in FIG. 2, the AI device 100 can include a communicator 110, an receiver 120, a learning processor 130, a sensing part 140, an generator 150, a memory 170, and a processor 180.

The communicator 110 can transmit and receive data to and from external devices such as other AI devices or AI servers by using wired/wireless communication technology. For example, the communicator 110 can transmit and receive sensor information, a user input, a learning model, and a control signal to and from external devices.

The communication technology used by the communicator 110 can include, for example, Global System for Mobile Communication (GSM), Code Division Multiple Access (CDMA), Long Term Evolution (LTE), 5G, Wireless LAN (WLAN), Wi-Fi, Bluetooth™, Radio Frequency Identification (RFID), Infrared Data Association (IrDA), ZigBee, and Near Field Communication (NFC).

The receiver 120 can acquire various types of data.

The receiver 120 can include a camera configured to input an image signal, a microphone configured to receive an audio signal, and a user receiver configured to receive information from a user. Here, the camera or the microphone can be treated as a sensor, and a signal acquired from the camera or the microphone can be referred to as sensing data or sensor information.

The receiver 120 can acquire training data for model training and input data to be used when acquiring an output using a learning model. The receiver 120 can acquire unprocessed input data. In this case, the processor 180 or the learning processor 130 can extract an input feature as preprocessing on the input data.

The learning processor 130 can train a model composed of an artificial neural network using the training data. Here, the train artificial neural network can be referred to as a learning model. The learning model can be used to infer the outcome value for new input data other than the training data, and the inferred value can be used as a basis for the determination to perform an operation.

In this case, the learning processor 130 can perform AI processing together with the learning processor of the AI server.

The learning processor 130 can include a memory integrated or implemented in the AI device 100. Alternatively, the learning processor 130 can be implemented using a memory 170, or an external memory directly coupled to the AI device 100, or a memory maintained in an external device.

The sensing part 140 can acquire at least one of internal information about the AI device 100, surrounding environment information related to the AI device 100, and user information, using various sensors.

Sensors included in the sensing part 140 can include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a LiDAR, and a radar.

The generator 150 can generate an output related to visual, auditory, or tactile sense.

In this case, the generator 150 can include a display configured to output visual information, a speaker configured to output auditory information, and a haptic module configured to output tactile information.

The memory 170 can store data supporting various functions of the AI device 100. For example, the memory 170 can store input data acquired through the receiver 120, training data, a learning model, a learning history, and the like.

The processor 180 can determine at least one executable operation of the AI device 100 based on information determined or generated using a data analysis algorithm or a machine learning algorithm. The processor 180 can control the components of the AI device 100 to perform the determined operation.

To this end, the processor 180 can request, search, receive, or utilize data of the learning processor 130 or the memory 170, and control the components of the AI device 100 to execute an operation predicted or determined to be desirable among the at least one executable operation.

Then, in the case where engagement of an external device is required to perform the determined operation, the processor 180 can generate a control signal for controlling the external device and transmit the generated control signal to the external device.

The processor 180 can acquire intention information about a user input and determine a requirement of the user based on the acquired intention information.

In this case, the processor 180 can acquire intention information corresponding to the user input using at least one of a speech-to-text (STT) engine configured to convert a speech input into a character string or a natural language processing (NLP) engine configured to acquire intention information about a natural language.

At least one of the STT engine or the NLP engine can include an artificial neural network that is at least partially trained according to a machine learning algorithm. In addition, at least one of the STT engine or the NLP engine can be trained by the learning processor 130 or a learning processor of the AI server, or can be trained by distributed processing thereof.

The processor 180 can collect history information including a user's feedback on the operation contents or operation of the AI device 100 and store the collected history information in the memory 170 or the learning processor 130, or can transmit the collected history information to an external device such as an AI server. The collected history information can be used to update the learning model.

The processor 180 can control at least some of the components of the AI device 100 to drive an application program stored in the memory 170. Furthermore, in order to drive the application program, the processor 180 can operate two or more of the components included in the AI device 100 in combination.

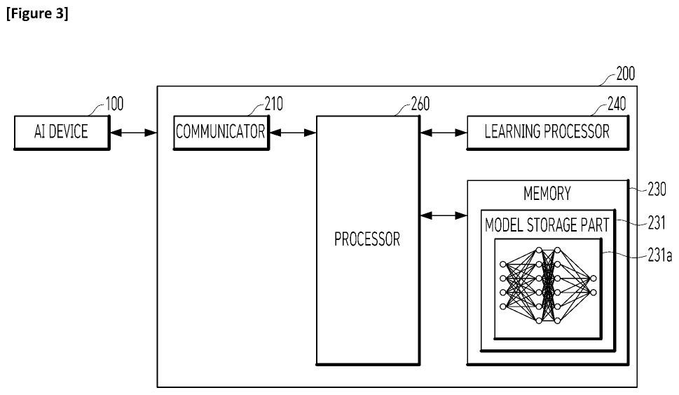

FIG. 3 is a block diagram illustrating a detailed configuration of an AI server 200 according to an embodiment of the present disclosure.

As shown in FIG. 3, the AI server 200 can refer to a device that trains an artificial neural network using a machine learning algorithm or uses a trained artificial neural network. Here, the AI server 200 can include a plurality of servers to perform distributed processing, or can be defined as a 5G network. In this case, the AI server 200 can be included as a part of the AI device 100 to perform at least part of the AI processing together.

The AI server 200 can include a communicator 210, a memory 230, a learning processor 240, and a processor 260.

The communicator 210 can transmit and receive data to and from an external device such as the AI device 100.

The memory 230 can include a model storage part 231. The model storage part 231 can store a model (or artificial neural network 231a) that is being trained or have been trained by the learning processor 240.

The learning processor 240 can train the artificial neural network 231a based on the training data. The learning model can be used on the AI server 200 of the artificial neural network, or can be used on an external device such as the AI device 100.

The learning model can be implemented by hardware, software, or a combination of hardware and software. When a portion or the entirety of the learning model is implemented in software, one or more instructions constituting the learning model can be stored in the memory 230.

The processor 260 can infer the outcome value for the new input data by using the learning model, and can generate a response or a control command based on the inferred outcome value.

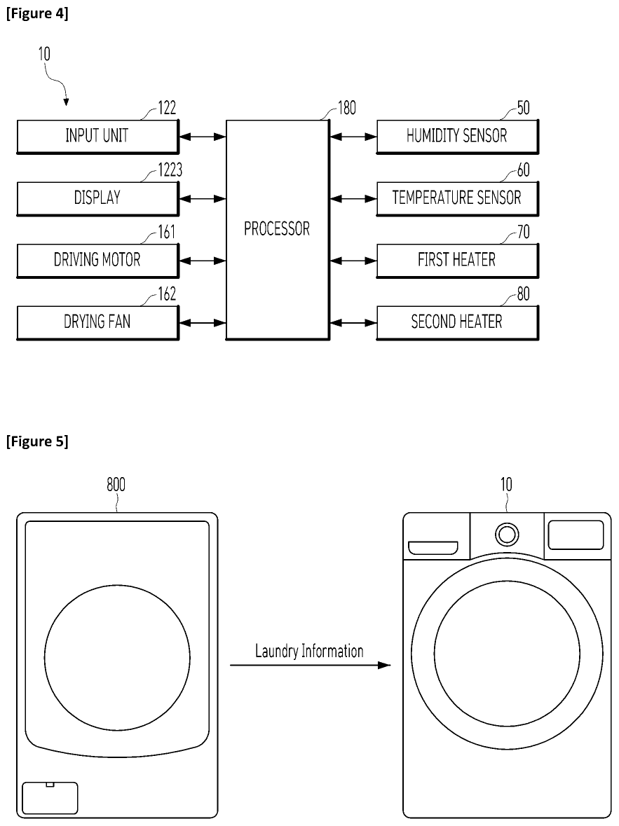

FIG. 4 is a block diagram illustrating a configuration of a drying machine according to an embodiment of the present disclosure.

The drying machine 10 can include a drying drum into which a drying target object is put, a humidity sensor 50 mounted on an inner circumferential surface of the drying drum, a front cabinet supporting a front portion of the drying drum, a blocking member mounted on a bottom portion of the front cabinet, a rear cabinet supporting a rear portion of the drying drum, and a lint filter washing device arranged below the drying drum.

For example, the humidity sensor 50 can be disposed inside the drying drum to sense humidity inside the drying drum.

The drying machine 10 can further include a suction duct for suctioning air to be supplied to the drying drum, a rear duct for connecting the suction duct and an air inflow hole formed in a rear surface of the drying drum, a guide duct connected to a bottom surface of the front cabinet to guide air discharged from the drying drum, a blower connected to an outlet end of the guide duct, and an exhaust duct connected to an outlet end of the blower. The lint filter washing device can be mounted at any point in the exhaust duct, such that lint contained in the air flowing along the exhaust duct is filtered while passing through the lint filter assembly provided in the lint filter washing device.

A middle cabinet is provided between the front cabinet and the rear cabinet to cover and protect the drying drum and various parts disposed under the drying drum. The middle cabinet can define both side surfaces and a top surface of the drying machine 10. A base plate defining a bottom portion of the drying machine 10 can be provided on a bottom surface of the middle cabinet, and the parts can be mounted on the base plate.

A control panel can be mounted on an upper side of the front surface of the front cabinet. The control panel can include an receiver 122 configured to select an operation mode (e.g., a drying mode) of the drying machine 10, and a display 123 configured to display various kinds of information including an operation state.

In addition, a temperature sensor 60 can be mounted on an outlet side of the drying drum. The temperature sensor 60 is mounted on the outlet side of the drying drum to sense a temperature value (hereinafter, referred to as a “drum outlet temperature value”) of the outlet side of the drying drum.

For example, the temperature sensor 60 can be mounted on an inner circumferential surface of the front end of the drying drum, and can be mounted on one side of an inner circumferential surface of the guide duct connected to the outlet side of the drying drum.

In addition, the blocking member is provided to prevent foreign substances contained in the drying target object, for example, coin or ballpoint pens, from being sucked into the guide duct during the drying process. Even when foreign substances such as lint are introduced into the guide duct, they are filtered out by the lint filter assembly mounted on the lint filter washing device, while other foreign substances, i.e., bulky and hard foreign substances, are blocked by the blocking member to remain in the drying drum. If substances other than the lint are sucked into the guide duct, they can cause damage to the blower or cause a rattling sound inside the exhaust duct. Accordingly, it is necessary to prevent the foreign material from leaving the drying drum by the blocking member. The blocking member can be detachably coupled to the front cabinet.

Further, a washing water supply pipe and a washing water drain pipe are connected to the lint filter washing device. An inlet end of the washing water supply pipe can be mounted on the rear cabinet to be connected to a water pipe connected from an external water supply source. An outlet end of the washing water supply pipe is connected to an inlet port of the control valve of the lint filter washing device. An inlet end of the washing water drain pipe is connected to the drain pump assembly of the lint filter washing device.

The blower includes a driving motor 161 configured to rotate the drying drum and a drying fan 162 connected to a rotation shaft of the driving motor 161.

The drying fan 162 is disposed at an outlet end of the guide duct to guide air guided to the guide duct via the drying drum to the exhaust duct. The drying drum is rotated by a pulley connected to the shaft of the driving motor 161, and a belt wound around an outer circumferential surface of the drying drum and the pulley. That is, when the driving motor 161 rotates, the pulley rotates. And when the pulley rotates, the belt rotates the drying drum. With this structure, the drying drum and the drying fan 162 rotate in the same direction when the driving motor 161 is operated.

An electric heater is mounted inside the rear duct of the drying machine 10. The electric heater generates hot air by heating the air to a high temperature before the air introduced into the suction duct is introduced into the drying drum.

In the drying process of the drying machine 10 having the above-described configuration, a drying target object is put into the drying drum through an input hole provided in the front cabinet. When a drying start command is input through the receiver 122, the blower is operated, and the drying drum and the drying fan 162 are rotated in one direction. Then, the air introduced into the suction duct is heated to a high temperature by the electric heater while flowing along the rear duct. The air heated to the high temperature is introduced into the drying drum through the rear surface of the drying drum along the rear duct. At this time, the hot and dry air introduced into the drying drum is changed into a hot and humid state while drying the drying target objects.

The hot and humid air, containing the lint generated from the drying target objects, passes through the blocking member and is guided into the guide duct. The hot and humid air guided into the guide duct is guided to the exhaust duct by the blower. The lint is filtered out by the lint filter assembly while the hot and humid air guided to the exhaust duct passes through the lint filter washing device. In addition, the lint filter washing device operates to separate the lint attached to the lint filter assembly and discharge the lint to the outside together with the washing water by the drain pump assembly.

The processor 180 can control the overall operation of the drying machine.

The drying machine 10 according to an embodiment of the present disclosure can include some or all of the components of the AI device 100 described with reference to FIG. 2, and can perform the function of the AI device 100 described with reference to FIG. 2.

In addition, the drying machine can include a dryer. The dryer can include at least one of a first heater 70 and a second heater 80. The dryer can perform a function of drying the drying target objects.

Since the drying machine of the present disclosure basically includes AI, and is clearly distinguished from the conventional technology.

FIG. 5 is a view illustrating a washing machine connected to a drying machine over a network according to an embodiment of the present disclosure.

A drying machine and a washing machine can be provided in one tower type, or can be provided separately, but connected over a wired/wireless network.

For example, as shown in FIG. 5, the drying machine 10 according to the embodiment of the present disclosure can receive information (drying target object analysis information) about washing completed by the washing machine 800 over a wired or wireless network.

As described above with reference to FIGS. 2 to 5, the drying machine according to the embodiment of the present disclosure is equipped with AI and presents a correction technique adaptive to an external environment around the drying machine based on the analysis of the default sensed value.

As described above, for the drying machine according to the conventional technology, a difference in initial value is generated due to an external environment. That is, due to an external environment (rainy season, etc.) around the drying machine, distortion can occur in the value (humidity/temperature, etc.) initially sensed by the drying machine before the drying machine starts drying. As a result, possibility of occurrence of error in the initial set value of the drying time increases.

Furthermore, since the drying machine according to the conventional technology does not consider an external environmental, an unnecessary drying period occurs, thereby increasing power consumption of the drying machine.

For example, while the drying machine performs the drying operation, sensing (of humidity/temperature, etc.) is performed for monitoring the inside of the drying machine, and distortion occurs in the sensed value for monitoring due to the external environment.

In addition, the drying time is controlled (adjusted) in real time based on the monitoring result, and the possibility of occurrence of error is increased in this operation.

On the other hand, the drying machine according to the embodiment of the present disclosure can address all the above-described issues by considering the external environment throughout the drying operation.

For example, the distortion of the initial sensed value can be minimized by considering the external environment, thereby minimizing the possibility of error that can occur in the initial drying time setting operation.

Furthermore, by considering the external environment even during the drying operation, the distortion of the sensed value for monitoring can be minimized, and the possibility of errors that can occur in the process of adjusting the drying time in real time can be minimized. That is, by considering the external environment, an unnecessary drying period (time) can be minimized.

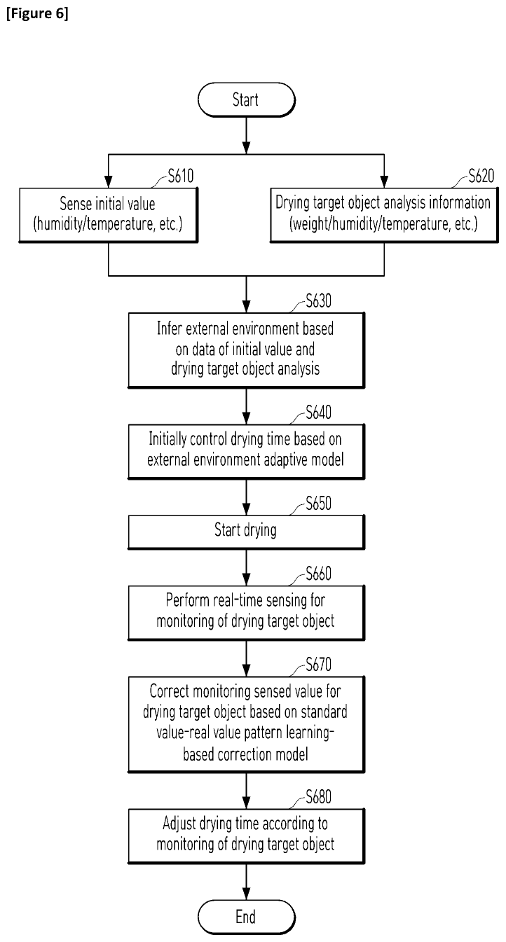

Various related embodiments will be described in more detail with reference to FIGS. 6 to 10.

FIG. 6 is a flowchart illustrating a chronological sequence of operations of a drying machine according to an embodiment of the present disclosure.

The drying machine according to an embodiment of the present disclosure performs an adaptive drying function based on external environment information using at least one AI modeling technique.

First, as shown in FIG. 6, the drying machine receives an initial sensed value before starting drying (S610), and receives drying target object analysis information (S620).

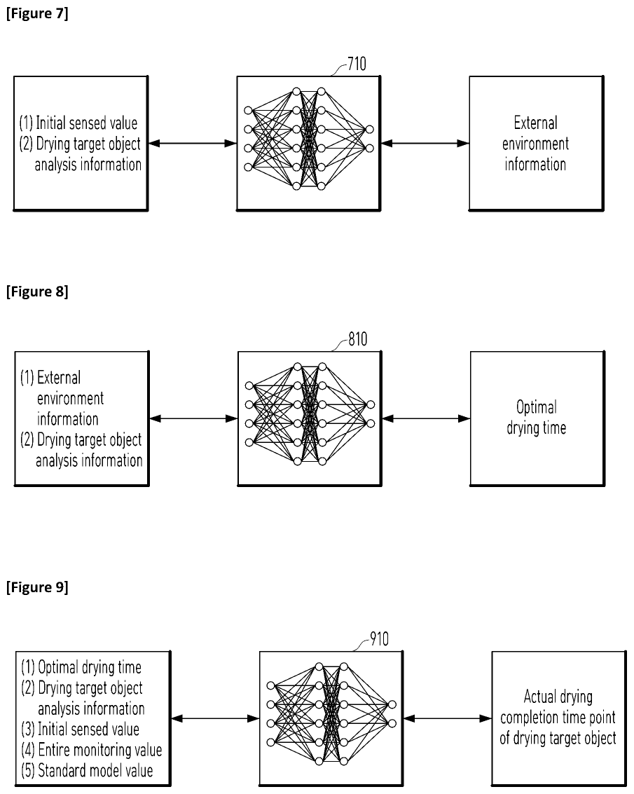

Furthermore, the drying machine is designed to acquire external environment information by providing the initial sensed value (S610) and the drying target object analysis information (S620) to a first AI model (S630). A more detailed modeling technique will be described below with reference to FIG. 7.

In addition, the drying machine provides the acquired external environment information and the drying target object analysis information to a second AI model to acquire an optimal drying time (S640). A more detailed modeling technique will be described below with reference to FIG. 8.

The drying machine starts to dry a drying target object based on the acquired external environment information (S650), and corrects the drying target object monitoring sensed value based on the standard value-actual value pattern learning-based correction model (S670). A more detailed modeling technique will be described below with reference to FIG. 9.

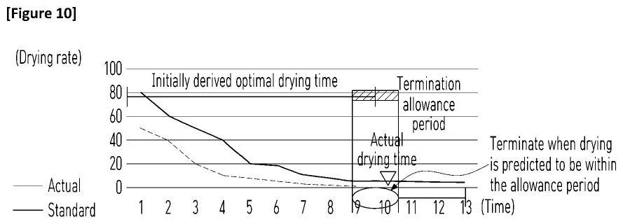

Finally, the drying machine adaptively adjusts the time according to the monitoring of the drying target object (S680). Accordingly, actual drying time and power consumption can be minimized. A more specific related result will be described in detail below with reference to FIG. 10.

Compared to the conventional technology shown in FIG. 1, the present disclosure additionally controls the operation of the drying machine in consideration of the external environment. In particular, it is designed to include at least one of operation S610, S630, S640, or S 670 shown in FIG. 6.

FIG. 7 is a diagram illustrating a method of acquiring external environment information using a first AI model according to an embodiment of the present disclosure. In particular, it is directly or indirectly related to operations S610, S620, and S630 of FIG. 6.

Unlike a preset standard environment, the drying machine is installed in a different environment in each home and is also heavily influenced by the weather outside (winter, rainy season, hot weather, etc.). That is, when a spatial environment in which a drying machine is installed is different from a standard environment, it can affect and distort sensing-based drying time control.

In order to address this issue, one embodiment of the present disclosure introduces a first AI model 710 shown in FIG. 7.

The first AI model 710 corresponds to a neural network trained based on external environment information labeled on an initial sensed value and drying target object analysis information. Here, the initial sensed value is designed to include at least one of a first humidity and first temperature before the drying target object is put into the drying machine, or a second humidity and second temperature after the drying target object is put. However, when all the four data are used, the accuracy of the labeled external environment information can be higher.

The drying target object information can be implemented in two embodiments. For example, when the drying machine is not paired with the washing machine, the sensor in the drying machine directly senses the weight/humidity/temperature of the drying target object put into the drying machine. On the other hand, when the drying machine and the washing machine are paired with each other through a communication connection, the drying machine receives and utilizes the information analyzed by the washing machine (the weight/humidity/temperature of the drying target object).

More specifically, for example, the first AI model 710 can train the neural network by labeling the external environment information on the initial sensed value and the drying target object analysis information described above. Here, the external environment information can be the output that the neural network should infer based on the initial sensed value/drying target object analysis information.

Accordingly, the neural network can infer a function for correlation between the initial sensed value/drying target object analysis information and the external environment information. In addition, parameters (weight, bias, etc.) of the neural network are optimized through evaluation of the inferred function of the neural network.

The external environment information can be represented as continuous values instead of being classified into a class. Accordingly, the neural network can be additionally trained using a regression algorithm.

That is, before the drying machine starts drying, the initial sensed value/the input value of the drying target object analysis information is inferred through the first AI model 710 shown in FIG. 7 to infer the external environment information (actual humidity/temperature of the surrounding external environment in which the drying machine is installed). Therefore, it is expected that there is no need to have a separate sensor outside the drying machine.

FIG. 8 is a diagram illustrating a method of acquiring an optimal drying time using a second artificial intelligence model according to an embodiment of the present disclosure. In particular, it is directly or indirectly related to operation S640 of FIG. 6.

According to the conventional technology, the drying time of the drying machine is initially controlled on the assumption that a standard environment is given. However, when designed as described above, the drying machine is not adaptive to changes in the external environment in which the drying machine is installed.

On the other hand, according to an embodiment of the present disclosure, an optimal drying time suitable for the external environment inferred through operation S630 of FIG. 6 and FIG. 7 is derived. To this end, one embodiment of the present disclosure introduces a second AI model 810 shown in FIG. 8.

The second AI model 810 corresponds to a neural network trained with an optimal drying time labeled on external environment information and drying target object analysis information.

That is, before the drying machine starts drying, the optimal drying time is derived through the second AI model 810 shown in FIG. 8.

By additionally using the external environment information as described above, an error that can occur when setting the initial drying time can be minimized. Furthermore, the optimal drying time acquired through operation S640 of FIG. 6 and the second AI model 810 of FIG. 8 can be additionally used when correcting the monitoring sensed value of operation S670 of FIG. 6, which is also within the scope of the present disclosure.

FIG. 9 is a diagram illustrating a method of predicting a drying completion time point of an actual drying target object using a third artificial intelligence model, according to an embodiment of the present disclosure. In particular, it is directly or indirectly related to operations S670 and S680 of FIG. 6.

According to the conventional technology, after the drying machine starts drying, it infers a drying condition based on current drying target object information alone (namely, the conventional technology only depends on a predefined standard value).

On the other hand, according to an embodiment of the present disclosure, even after the drying machine starts drying, the drying condition can be more accurately inferred in real time by additionally using not only currently sensed information about the drying target object, but also external environment information and an initial sensed value.

To this end, one embodiment of the present disclosure introduces a third AI model 910 shown in FIG. 9.

The third AI model 910 corresponds to a neural network trained using an actual drying degree and an actual drying completion time point, which are labeled on an optimal drying time, drying target object analysis information, an initial sensed value, an entire monitoring value, a standard model value, and the like.

A more specific embodiment of adaptively changing the drying end time point based on actual drying completion time information obtained by obtaining the outcome value in FIG. 9 will be described below with reference to FIG. 10.

FIG. 10 is a diagram illustrating an embodiment of changing a drying completion time point of an actual drying target object according to the prediction method of FIG. 9. In particular, FIG. 10 illustrates that the drying rate for the same drying target object differs between the standard environment (not considering external environment) and the actual environment (considering the external environment according to the present disclosure).

First, it is assumed that the drying time is set to 10 minutes in operation S640 of FIG. 6 before the drying starts. In this case, as shown in FIG. 10, the termination allowance period is further set to 9 to 11 minutes.

However, according to an embodiment of the present disclosure, even after the drying machine starts drying, the internal sensing data is adjusted for distortion in consideration of the external environment.

Then, based on the adjusted sensing data, the time at which the actual drying rate will reach 0%, that is, the drying prediction time, is designed to be finely adjusted within the termination allowance period. Therefore, there is no need to continue drying up to 11 minutes, which is the last time of the termination allowance period, and it is expected that unnecessary power consumption will be reduced.

In other words, according to one of the embodiments of the present disclosure described with reference to FIGS. 2 to 10, the drying time is controlled in an adaptive manner according to the environment (humidity/temperature, etc.) of the installation space for the drying machine.

Furthermore, distortion occurring in a sensor space in the drying machine can be corrected according to an external environment in which the drying machine is installed, thereby enabling more accurate monitoring of the dried condition of the drying target object in the drying machine.

Finally, as the external environmental is considering even during the monitoring operation after the drying starts, the drying time can be more accurately predicted, and thus power consumption of the drying machine can be reduced.

The examples of the present disclosure can be embodied as computer readable code on a medium on which a program is recorded. The computer readable medium includes all kinds of recording devices capable of storing data readable by a computer system is stored. Examples of computer-readable media include applications, hard disk drives (HDDs), solid state disks (SSDs), silicon disk drives (SDDs), ROMs, RAMs, CD-ROMs, magnetic tapes, floppy disks, and optical data storage devices. In addition, the computer can include a controller 180 of the terminal. Accordingly, the foregoing detailed description is to be construed in all aspects as illustrative and not restrictive. The scope of the present disclosure should be determined by the reasonable interpretation of the appended claims, and all changes within the equivalents of this disclosure are included within the scope of the present disclosure.

### MODE FOR DISCLOSURE

As described above, various forms for implementing embodiments of the present disclosure have been described in the best mode. It will be appreciated by those skilled in the art that the embodiments can be carried out independently, or two or more of the embodiments can be combined within the scope of the present disclosure.

### INDUSTRIAL APPLICABILITY

The present disclosure is applicable to various drying machines, and is thus considered to be industrially applicable.

What is claimed is:

1. A method of controlling a drying machine for performing a drying function based on external environment information, the method comprising:
receiving an initial sensed value before drying starts;
receiving drying target object analysis information;
providing the initial sensed value and the drying target object analysis information to a first artificial intelligence model and acquiring external environment information; and
drying a drying target object based on the acquired external environment information,
wherein the first artificial intelligence model is a neural network trained using the external environment information labeled on the drying target object analysis information and the initial sensed value.

2. The method of claim 1, wherein the initial sensed value comprises at least one of a first humidity, a first temperature, a second humidity, or a second temperature,
wherein the first humidity and the first temperature are given before the drying target objects is put into the drying machine,
wherein the second humidity and the second temperature are given after the drying target object is put into the drying machine.

3. The method of claim 2, wherein the receiving of the drying target object analysis information comprises:
receiving information about at least one of a weight, a humidity, or a temperature of laundry from a washing machine communicatively connected to the drying machine in a wired or wireless manner.

4. The method of claim 3, further comprising:
providing the acquired external environment information and the drying target object analysis information to a second artificial intelligence model and acquiring an optimal drying time,
wherein the second artificial intelligence model is a neural network trained based on the optimal drying time labeled on the drying target object analysis information and the external environment information.

5. The method of claim 4, further comprising:
providing the acquired optimal drying time, the drying target object analysis information, the initial sensed value, an entire monitoring value, and a standard model value to a third artificial intelligence model and changing an actual drying completion time point of the drying target object,
wherein the third artificial intelligence model is a neural network trained based on the actual drying completion time point of the drying target object labeled on the optimal drying time, the drying target object analysis information, the initial sensed value, the entire monitoring value, and the standard model value.

6. A drying machine for performing a drying function based on external environment information, the drying machine comprising:
a sensor configured to receive an initial sensed value before drying starts;
a communication module configured to receive drying target object analysis information;
a processor configured to provide the initial sensed value and the drying target object analysis information to a first artificial intelligence model and acquire external environment information; and
a dryer configured to dry a drying target object based on the acquired external environment information,
wherein the first artificial intelligence model is a neural network trained using the external environment information labeled on the drying target object analysis information and the initial sensed value.

7. The drying machine of claim 6, wherein the initial sensed value comprises at least one of a first humidity, a first temperature, a second humidity, or a second temperature,
wherein the first humidity and the first temperature are given before the drying target objects is put into the drying machine,
wherein the second humidity and the second temperature are given after the drying target object is put into the drying machine.

8. The drying machine of claim 7, wherein the communication module receives information about at least one of a weight, a humidity, or a temperature of laundry from a washing machine communicatively connected to the drying machine in a wired or wireless manner.

9. The drying machine of claim 8, wherein the processor provides the acquired external environment information and the drying target object analysis information to a second artificial intelligence model and acquiring an optimal drying time,
wherein the second artificial intelligence model is a neural network trained based on the optimal drying time labeled on the drying target object analysis information and the external environment information.

10. The drying machine of claim 9, wherein the processor provides the acquired optimal drying time, the drying target object analysis information, the initial sensed value, an entire monitoring value, and a standard model value to a third artificial intelligence model and changing an actual drying completion time point of the drying target object,
wherein the third artificial intelligence model is a neural network trained based on the actual drying completion time point of the drying target object labeled on the optimal drying time, the drying target object analysis information, the initial sensed value, the entire monitoring value, and the standard model value.
